(19) United States
(12) Patent Application Publication
(10) Pub. No.: US 2026/0149190 A1
(43) Pub. Date: May 28, 2026

(54) Charging Terminal and Charging Device

(71) Applicants: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(72) Inventors: Yun (Steven) Wang, Suzhou (CN); Weidong Zhang, Shanghai (CN); Jianwen (Gerry) Zhang, Suzhou (CN)

(73) Assignees: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(21) Appl. No.: 19/399,834

(22) Filed: Nov. 25, 2025

(30) Foreign Application Priority Data
Nov. 25, 2024 (CN) 202422880084.4

(51) Int. Cl. H01R 4/02; H01R 4/58

(52) U.S. Cl. CPC H01R 4/023; H01R 4/58

(57) ABSTRACT

A charging terminal includes a mating part having a cylindrical shape that is matable with a columnar mating terminal, and a welding part capable of being welded onto a cable to electrically connect with the cable. The mating part is an integral stamped part. The welding part is an integral cold heading part. A front end of the welding part is welded, riveted or crimped to a rear end of the mating part.

### CROSS-REFERENCE TO RELATED APPLICATION

This application claims the benefit of the filing date under 35 U.S.C. § 119(a)-(d) of Chinese Application No. 202422880084.4, filed on Nov. 25, 2024.

### FIELD OF THE INVENTION

The present invention relates to a charging terminal and a charging device comprising the charging terminal.

### BACKGROUND OF THE INVENTION

A charging terminal of a charging dock used for an electric vehicle is usually an integral machined part. The current carrying capacity of the machined terminal is high, but the manufacturing cost is also high.

In order to reduce costs, the charging terminal is commonly stamped, but the current carrying capacity of a stamped charging terminal is poor. In order to shorten charging time, the charging current of electric vehicles is increasing, with a maximum charging current of up to 1000 A. The existing stamped charging terminal cannot meet this requirement.

### SUMMARY OF THE INVENTION

A charging terminal includes a mating part having a cylindrical shape that is matable with a columnar mating terminal, and a welding part capable of being welded onto a cable to electrically connect with the cable. The mating part is an integral stamped part. The welding part is an integral cold heading part. A front end of the welding part is welded, riveted or crimped to a rear end of the mating part.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a charging terminal according to an exemplary first embodiment of the present invention when viewed from the front side;

FIG. 2 shows an illustrative exploded view of the charging terminal according to the exemplary first embodiment of the present invention when viewed from the front side;

FIG. 3 shows an illustrative perspective view of the charging terminal according to the exemplary first embodiment of the present invention when viewed from the rear side;

FIG. 4 shows an illustrative exploded view of the charging terminal according to the exemplary first embodiment of the present invention when viewed from the rear side;

FIG. 5 shows an illustrative perspective view of the charging terminal according to the exemplary second embodiment of the present invention when viewed from the front side;

FIG. 6 shows an illustrative exploded view of the charging terminal according to the exemplary second embodiment of the present invention when viewed from the front side;

FIG. 7 shows an illustrative perspective view of the charging terminal according to the exemplary second embodiment of the present invention when viewed from the rear side; and

FIG. 8 shows an illustrative exploded view of the charging terminal according to the exemplary second embodiment of the present invention when viewed from the rear.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

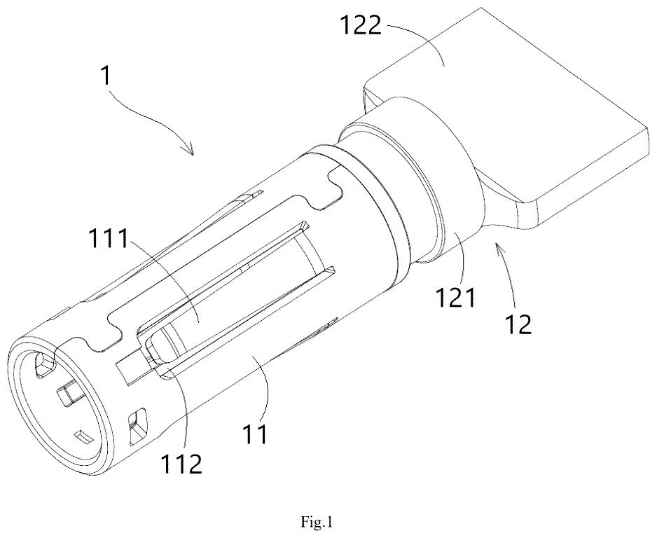

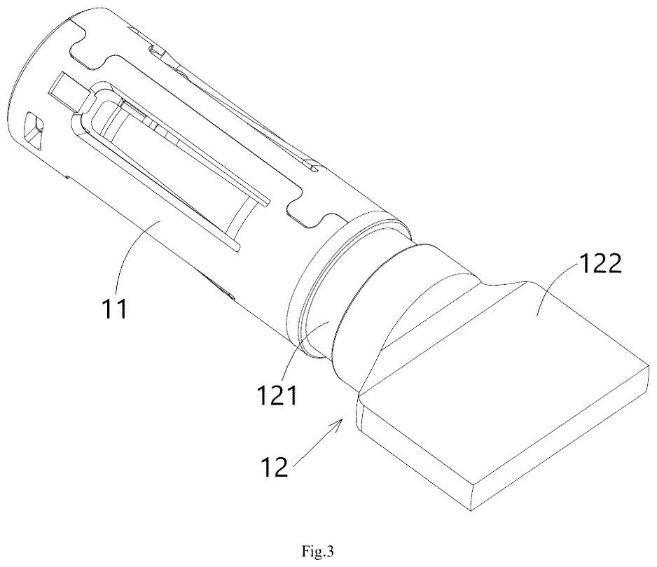

As shown in FIGS. 1 to 4, in a first exemplary embodiment of the present invention, a charging terminal 1 is disclosed. The charging terminal 1 includes a mating part 11 and a welding part 12. The mating part 11 is a hollow cylindrical shape, used for mating with a columnar mating terminal. The welding part 12 is used to weld to a cable for electrical connection with the cable. The mating part 11 is an integral stamped part, and the welding part 12 is an integral cold heading part produced by cold heading, alternatively referred to as cold forming. A front end of the welding part 12 is welded, riveted or crimped to the rear end of the mating part 11.

In various embodiments, the mating part 11 can be a copper component or a copper alloy component, and the welding part 12 can be an aluminum component, a copper component, a copper alloy component, or an aluminum alloy component.

As shown in FIGS. 1 to 4, in the illustrated embodiment, a plurality of elastic arms 111 are formed on a peripheral wall of the mating part 11, and the multiple elastic arms 111 are distributed at intervals in a circumferential direction of the mating part 11 for electrical contact with the mating terminal inserted into the mating part 11. A plurality of windows 112 are formed on the peripheral wall of the mating part 11, and multiple elastic arms 111 are respectively suspended in the multiple windows 112. A rear end of the elastic arm 111 is connected to the rear side edge of the window 112, and a front end of the elastic arm 111 slightly protrudes into an inner cavity of the mating part 11 to make electrical contact with the inserted mating terminal.

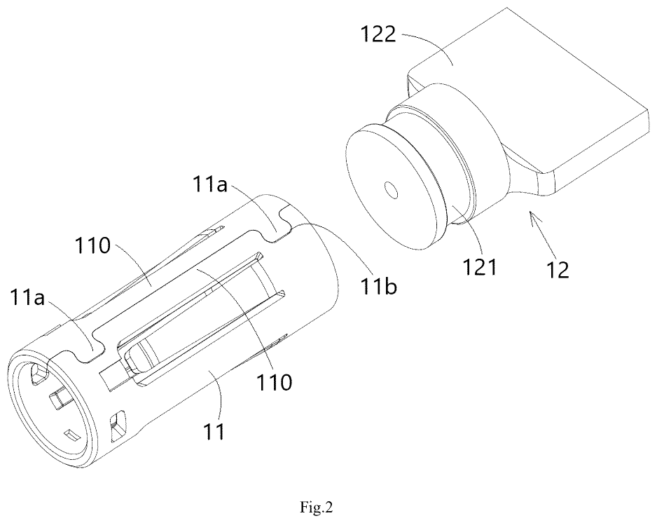

As shown in FIG. 2, in the illustrated embodiment, the mating part 11 has two splicing edges 110 extending along its axial direction. A protrusion 11a is formed on one of the two splicing edges 110, and a groove 11b is formed on the other to engage with the protrusion 11a, in order to splice the two splicing edges 110 together. In the illustrated embodiment, the protrusions 11a and grooves 11b on the splicing edge 110 are in the shape of a dovetail, T, or Ω. In this way, it can prevent the two splicing edges 110 from being detached in the circumferential direction of the mating part 11. In the illustrated embodiment, two protrusions 11a are formed on one splicing edge 110 of the mating part 11, and the two protrusions 11a are respectively close to the front and rear ends of the mating part 11. There are two grooves 11b formed on the other splicing edge 110 of the mating part 11, which are respectively close to the front and rear ends of the mating part 11.

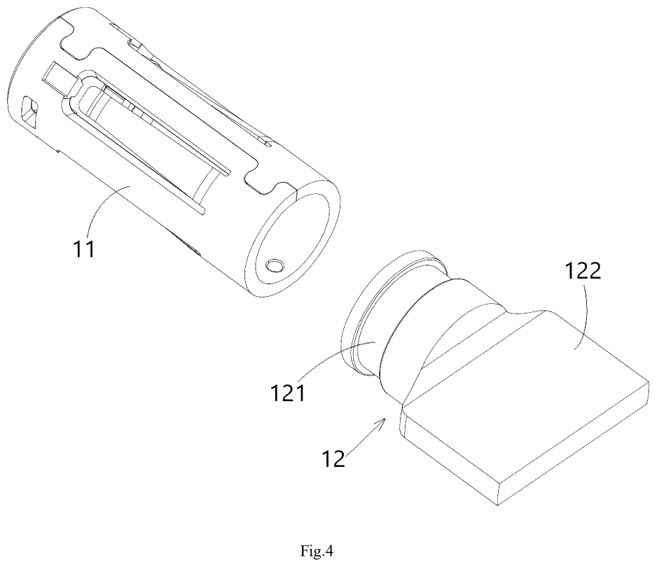

As shown in FIGS. 2 and 4, in the illustrated embodiment, the welding part 12 has a cylindrical front end 121 and a flat rear end 122. The cylindrical front end 121 of the welding part 12 is welded to the rear end of the mating part 11, and the flat rear end 122 of the welding part 12 is suitable for welding to the conductor of the cable.

In another exemplary embodiment of the present invention, a charging device is also disclosed. The charging device includes a housing and a charging terminal 1. The charging terminal 1 is set in the housing. The charging device further comprises a cable, one end of which extends into the housing and is welded to the flat rear end 122 of the welding part 12 of the charging terminal 1. In various embodiments, the charging device is a charging dock or a charging gun.

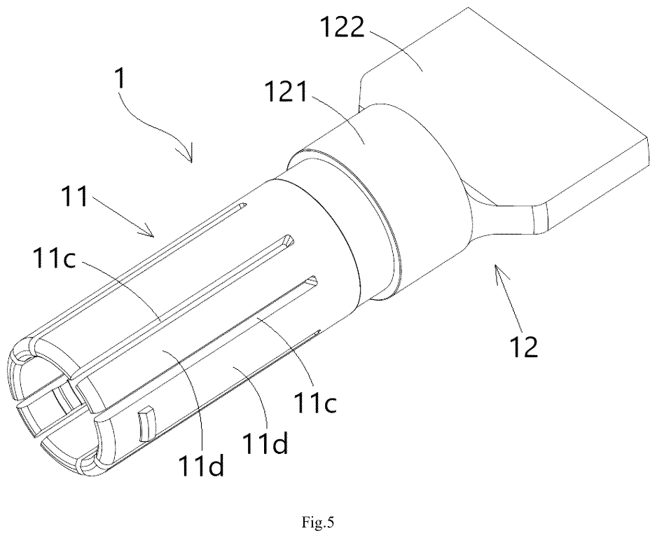

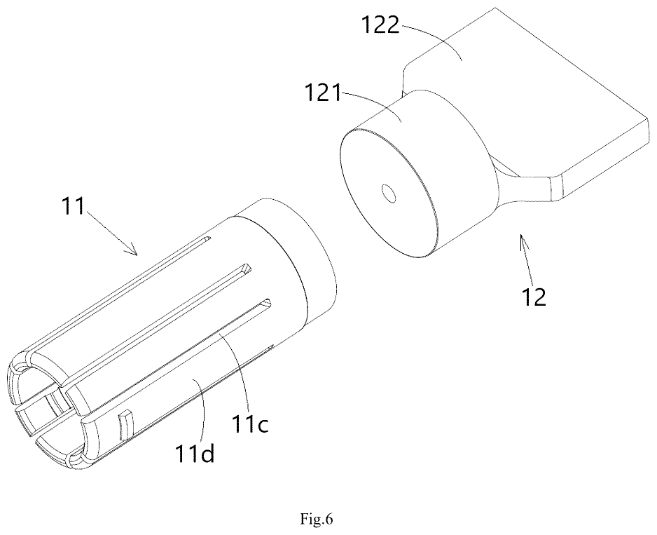

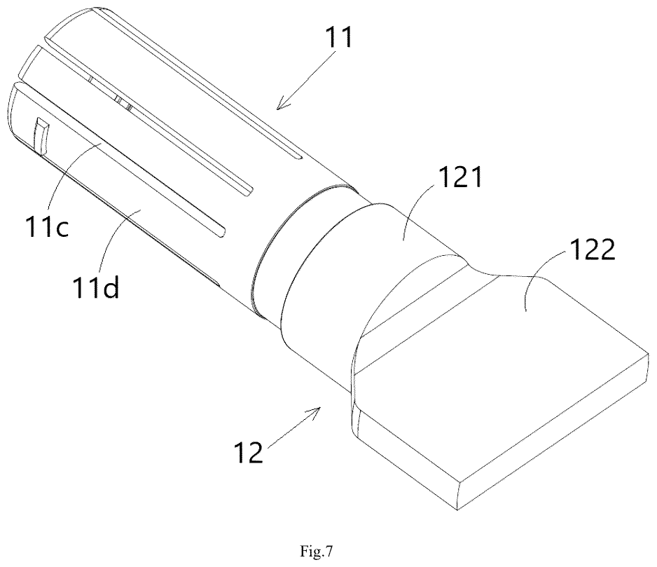

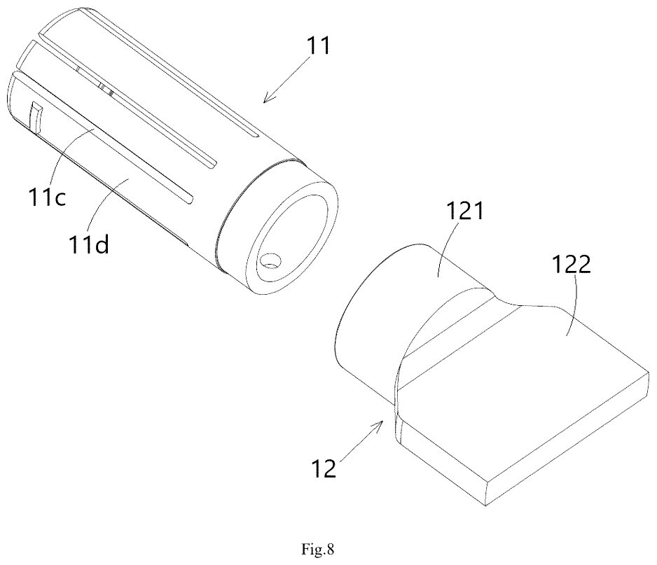

FIGS. 5 to 8 show a second embodiment of the charging terminal 1 according to the present invention. The charging terminal 1 includes a mating part 11 and a welding part 12. The mating part 11 is a hollow cylindrical shape, used for mating with a columnar mating terminal =. The welding part 12 is used to weld to a cable for electrical connection with the cable. The mating part 11 is an integral cold heading component, and the welding part 12 is an integral cold heading component. A front end of welding part 12 is welded, riveted, or crimped to a rear end of mating part 11.

In various embodiments, the mating part 11 can be a copper component or a copper alloy component, and the welding part 12 can be an aluminum component, a copper component, a copper alloy component, or an aluminum alloy component.

As shown in FIGS. 5 to 8, in the illustrated embodiment, a plurality of partition grooves 11c are formed on the peripheral wall of the mating part 11, which are distributed at intervals in the circumferential direction of the mating part 11 and extend along the axial direction of the mating part 11 all the way to the front end face of the mating part 11, so that the peripheral wall of the mating part 11 is divided into multiple cantilever parts 11d, which are used to make electrical contact with the mating terminal inserted into the mating part 11. In the illustrated embodiment, an extension length of the partition groove 11c and the cantilever part 11d in the axial direction of the mating part 11 is greater than half of the axial length of the mating part 11 and less than the axial length of the mating part 11.

As shown in FIGS. 5 to 8, in the illustrated embodiment, the welding part 12 has a cylindrical front end 121 and a flat rear end 122. The cylindrical front end 121 of the welding part 12 is welded to the rear end of the mating part 11, and the flat rear end 122 of the welding part 12 is suitable for welding to the conductor of the cable.

In another exemplary embodiment of the present invention, a charging device is also disclosed. The charging device includes a housing and a charging terminal 1. The charging terminal 1 is set in the housing. In an embodiment, the charging device further comprises a cable, one end of which extends into the housing and is welded to the flat rear end 122 of the welding part 12 of the charging terminal 1. In various embodiments, the charging device is a charging dock or a charging gun.

In the aforementioned exemplary embodiments according to the present invention, at least a part of the charging terminal is a cold heading component, which not only has low manufacturing cost but also can carry a large charging current.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A charging terminal, comprising:
a mating part having a cylindrical shape and matable with a columnar mating terminal; and
a welding part capable of being welded onto a cable to electrically connect with the cable, the mating part is an integral stamped part, the welding part is an integral cold heading part, a front end of the welding part is welded, riveted or crimped to a rear end of the mating part.

2. The charging terminal according to claim 1, wherein the mating part is made of copper or copper alloy.

3. The charging terminal according to claim 2, wherein the welding part is made of aluminum, copper, copper alloy, or aluminum alloy.

4. The charging terminal according to claim 1, wherein a plurality of elastic arms are formed on a peripheral wall of the mating part, the elastic arms are distributed at intervals in a circumferential direction of the mating part and electrically contact the columnar mating terminal inserted into the mating part.

5. The charging terminal according to claim 4, wherein a plurality of windows are formed on the peripheral wall of the mating part, the elastic arms are each suspended in one of the windows.

6. The charging terminal according to claim 5, wherein a rear end of each of the elastic arms is connected to a rear side edge of one of the windows.

7. The charging terminal according to claim 6, wherein a front end of each of the elastic arms protrudes into an inner cavity of the mating part to electrically contact the columnar mating terminal.

8. The charging terminal according to claim 1, wherein the mating part has a pair of splicing edges extending along an axial direction, a protrusion is formed on one of the splicing edges and a groove is formed on the other of the splicing edges, the protrusion is engaged with the groove to secure the splicing edges together.

9. The charging terminal according to claim 8, wherein the protrusion and the groove are in a shape of a dovetail, T or Ω.

10. The charging terminal according to claim 8, wherein the protrusion is one of a pair of protrusions formed on the one of the splicing edges, the protrusions are respectively close to a front end and the rear end of the mating part.

11. The charging terminal according to claim 10, wherein the groove is one a pair of grooves formed on the other of the splicing edges, the grooves are respectively close to the front end and the rear end of the mating part.

12. The charging terminal according to claim 1, wherein the front end of the welding part has a cylindrical shape and a rear end of the welding part has a flat shape, the front end of the welding part is welded to the rear end of the mating part, the rear end of the welding part is capable of being welded to a conductor of the cable.

13. A charging terminal, comprising:
a mating part having a cylindrical shape and matable with a columnar mating terminal; and
a welding part capable of being welded onto a cable to electrically connect with the cable, the mating part is an integral cold heading part, the welding part is an integral cold heading part, a front end of the welding part is welded, riveted or crimped to a rear end of the mating part.

14. The charging terminal according to claim 13, wherein the mating part is made of copper or copper alloy, and the welding part is made of aluminum, copper, copper alloy, or aluminum alloy.

15. The charging terminal according to claim 13, wherein a plurality of partition grooves are formed on a peripheral wall of the mating part, the partition grooves are distributed at intervals in a circumferential direction of the mating part and extend along an axial direction of the mating part to a front end face of the mating part, the peripheral wall of the mating part is divided into a plurality of cantilever parts for electrical contact with the columnar mating terminal inserted into the mating part.

16. The charging terminal according to claim 15, wherein an extension length of each of the partition grooves and the cantilever parts in the axial direction of the mating part is greater than half of the axial length of the mating part and less than the axial length of the mating part.

17. The charging terminal according to claim 13, wherein the welding part has a cylindrical front end and a flat rear end, the cylindrical front end of the welding part is welded to the rear end of the mating part, and the flat rear end of the welding part capable of being welded to a conductor of the cable.

18. A charging device, comprising:
a housing; and
a charging terminal disposed in the housing, the charging terminal includes:
a mating part having a cylindrical shape and matable with a columnar mating terminal; and
a welding part capable of being welded onto a cable to electrically connect with the cable, the mating part is an integral stamped part, the welding part is an integral cold heading part, a front end of the welding part is welded, riveted or crimped to a rear end of the mating part.

19. The charging device according to claim 18, further comprising the cable having an end extending into the housing and welded to a flat rear end of the welding part.

20. The charging device according to claim 18, wherein the charging device is a charging dock or a charging gun.
